(19) United States
(12) Patent Application Publication
(10) Pub. No.: US 2009/0145443 A1
(43) Pub. Date: Jun. 11, 2009

(54) MAGNETIC POSITIONER

(76) Inventor: Peter Dreyfuss, Naples, FL (US)

Correspondence Address: CARLSON, GASKEY & OLDS, P.C., 400 WEST MAPLE ROAD, SUITE 350, BIRMINGHAM, MI, 48009, US

(21) Appl. No.: 12/328,812

(22) Filed: Dec. 5, 2008

Related U.S. Application Data
(60) Provisional application No. 61/012,165, filed on Dec. 7, 2007.

(51) Int. Cl. A61G 15/00

(52) U.S. Cl. 128/845

(57) ABSTRACT

An example surgical positioner includes a first support member and a second support member moveably joined to the first support member. A magnet is operative to generate a magnetic force that attracts the first support member toward the second support member to resist relative movement between the first support member and the second support member.

### CROSS-REFERENCE TO RELATED APPLICATIONS

This application claims priority to U.S. Provisional Application No. 61/012,165, which was filed on 7 Dec. 2007 and is incorporated herein by reference.

### BACKGROUND

Holding the position of a patient is often necessary during surgeries or other medical procedures. For example, surgeons may use a positioner to hold the position of a patient's limb during an arthroscopic surgery. The positioners can be adjusted to hold the limb in one or more desired positions. Some positioners are used to hold surgical tools.

Positioners often include moveable arms, which are manipulated to a position appropriate for holding the patient, and are then locked to prevent relative movement between the arms. The patient's limb is typically secured to one of the locked arms. Joints connecting the arms often include locking mechanisms, such as gears or pins, for holding the position of the arms. These locking mechanisms provide limited adjustability, because the arms are only locked when the gears or pins are engaged, and the gears or pins have a limited number of engagement locations. Other, more adjustable, positioners use hydraulic fluid in the joints to hold the position of the arms.

### SUMMARY

An example surgical positioner includes a first support member and a second support member moveably joined to the first support member. A magnet is operative to generate a magnetic force that attracts the first support member toward the second support member to resist relative movement between the first support member and the second support member.

Another example surgical positioning assembly includes a base, a first member secured to the base, and a second member pivotably secured to the first member at a first joint location. An electromagnet system is operative to vary an electromagnetic force near the first joint location between a stronger electromagnetic force and a weaker electromagnetic force. The stronger electromagnetic force provides greater resistance to relative movement between the second member and the first member than the weaker electromagnetic force.

A method of positioning a surgical positioner, comprising the steps of pivoting a first member relative to a second member to a first pivot position, and holding the first member in the first pivot position using a magnet that attracts the first member toward the second member.

These and other features of the present invention can be best understood from the following specification and drawings. The following is a brief description of the drawings:

### BRIEF DESCRIPTION OF THE DRAWINGS

FIG. 1 shows a perspective view of an example magnetic positioner;

FIG. 2 shows a close up view of one of the FIG. 1 magnetic positioner joints;

FIG. 3 shows a close up view of the ball portion of the FIG. 2 joint;

FIG. 4 shows a sectional view through line 4-4 of FIG. 3; and

FIG. 5 shows a partial schematic view of the magnets within the FIG. 1 magnetic positioner.

### DETAILED DESCRIPTION

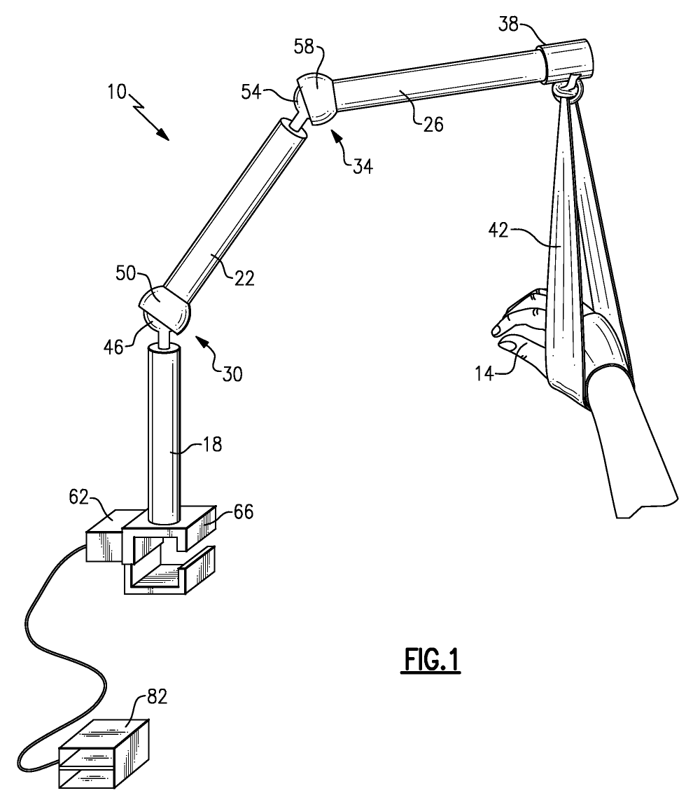

FIG. 1 illustrates an example magnetic positioner 10 for securing a patient's limb 14 during a surgery or other medical procedure. The magnetic positioner 10 secures a surgical instrument in another example.

The magnetic positioner 10 includes a base member 18, a first movable member 22, and a second movable member 26. One end of the first movable member 22 is moveably joined to the base member 18 at a first joint 30. A second joint 34 joins the other end of the first movable member 22 to the second movable member 26. An attachment 38 is mounted to the second movable member 26. In this example, a sling or bandage 42 secured to the attachment 38 secures the limb 14 relative to the attachment 38. Thus holding the position of the second moveable member 26 holds the position of the limb 14.

In this example, the first joint 30 includes a first ball portion 46, or rounded portion, and a first socket portion 50, or cupped portion. The first joint 30 has an unlocked position where the first moveable member 22 is free to pivot about the first ball portion 46 relative to the base member 18 and a locked position limiting such movement. The example magnetic positioner 10 can support 15-20 pounds of weight suspended from the attachment 38 when the joints 30 are 34 are in the locked position.

The example second joint 34 is similar to the first joint 30 and includes a second ball portion 54 and a second socket portion 58. When the second joint 34 is in an unlocked position, the second moveable member 26 is free to pivot about the ball portion 54 relative the first moveable member 22. A locked position of the second joint 34 limits this movement.

When powered, an electromagnetic generator 62 generates a magnetic field that magnetizes areas of the first ball portion 46 and the second ball portion 54. As the first socket portion 50 and the second socket portion 58 are typically made of a magnetic ferrous material, magnetizing the first ball portion 46 attracts the first socket portion 50 toward the first ball portion 46, and magnetizing the second ball portion 54 attracts the second socket portion 58 toward the second ball portion 54. When both joints 30 and 34 are magnetized, friction locks the joints 30 and 34 and prevents relative movement between the base member, the first moveable member 22, and the second moveable member 26.

In this example, the first ball portion 46 of the joint 30 extends from an upper end of the base member 18. A clamp 66 near the lower end secures the base member 18 to a bedside rail (not shown), for example. In another example, the base member 18 is secured to a moveable stand. The electromagnetic generator 62 is secured adjacent the clamp 66 in this example, and is in communication with a foot pedal 82. Actuating the foot pedal 82 causes the electromagnetic generator 62 to produce magnetizing power in a known manner.

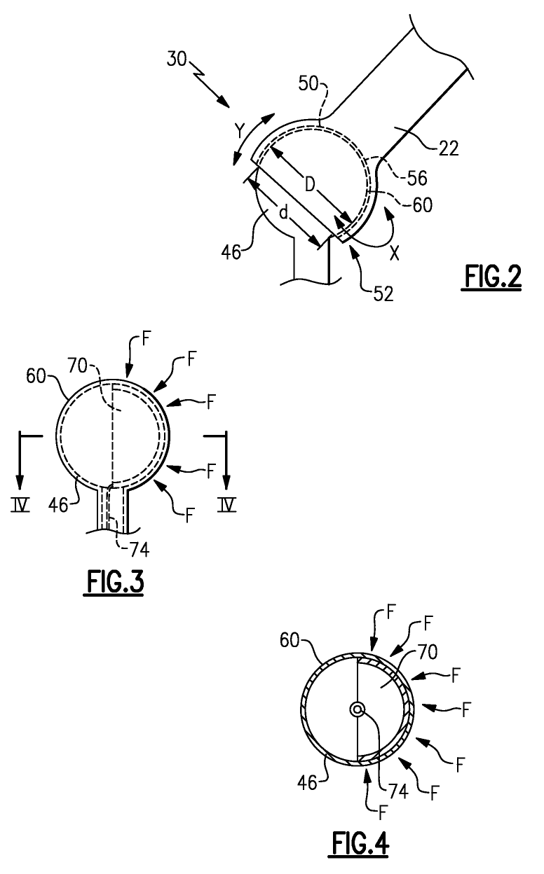

Referring now to FIG. 2, the first movable member 22 engages the first ball portion 46 with the first socket portion 50. When the joint 30 is not magnetized, the first movable member 22 is free to move relative to the first ball portion 46. The first socket portion 50 includes an area 52 having an inner diameter d that is smaller than an inner diameter D of the first ball portion 46. The socket portion 50 thus contacts the ball portion 46 to limit movement of the first socket portion 50 away from the first ball portion 46. As known, ball and socket joints such as the first joint 30 provide movement and adjustability in several directions, such as the directions X and Y as shown. Providing the joint 30 facilitates manipulating the first moveable member 22 into a suitable position for surgery.

As shown in FIG. 3, the example first ball portion 46 is hollow and includes a magnet 70, such as an electromagnetic magnet, at least partially lining the interior surface. A cord 74 joins the magnet 70 and extends down through the base member 18 to link the magnet 70 with the electromagnetic generator 62 (FIG. 1). When powered, the magnet 70 generates a magnetic field that provides a magnetic attracting force F.

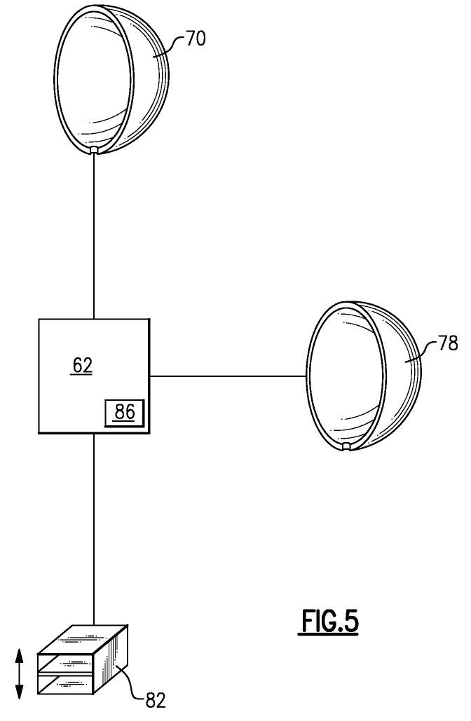

FIG. 4 illustrates another view of the magnet 70, which, in this example, covers approximately half of the interior of the first ball portion 46. When magnetized, the magnet 70 attracts the first socket portion 50 (FIG. 2) toward the center of the first ball portion 46. Friction between an inner surface 56 of the first socket portion 50 and an outer surface 60 of the first ball portion 46 hold the position of the joint 30 when the magnet 70 is magnetized. The friction resists relative movement between the inner surface 56 and the outer surface 60. The second joint 34 operates in a similar manner to the first joint 30.

Referring now to FIG. 5 with continuing reference to FIG. 1, the second ball portion 54 of the second joint 30 includes a second magnet 78 in communication with the electromagnetic generator 62. The foot pedal 82 controls the electromagnetic generator 62 to provide power to each of the magnets 70 and 78. In one example, the magnets 70 and 78 are controlled together. That is, the electromagnetic generator 62 powers both magnets 70 and 78 at the same time to lock both of the joints 30 and 34 together. In another example, the electromagnetic generator independently powers the magnets 70 and 78, which permits locking of the first joint 30 while permitting movement of the second joint 34. In such an example, the magnets 70 and 78 and separately connected to the electromagnetic generator 62, which includes a controller 86 for controlling power from the electromagnetic generator 62 to the magnets 70,78

Although shown as controlled by a foot pedal 82 actuated by a surgeon, other examples may include controlling the positioner 10 using a voice commands, a remote control, or another medical professional.

In one example method of positioning the limb 14, the surgeon actuates the foot pedal 82 to release both of the joints 30 and 34. The surgeon then grasps and moves the first moveable member 22 to a suitable position and then locks the first joint 30 by actuating the foot pedal 82. Next, the surgeon positions the second moveable member 22 and locks the second joint 34 by again actuating the foot pedal 82. A person skilled in the art would know how to develop a control system suitable for powering the magnets 70 and 78 based on such commands or how to program the controller 86 to carry out such commands based on the input from the foot pedal 82.

In some examples, the electromagnetic generator 62 may produce weaker magnetic field within the joints 30 and 34 to support some of the weight of the first member 22 and the second member 26, which assists the surgeon when manipulating the first member 22 and the second member 26 as the surgeon would not need to support the entire weight of the second member 26 when manipulating the second member 26 relative to the first member 22.

Features of this embodiment include securing moveable members relative to each other without utilizing moving parts. Another feature is enhanced adjustability of moveable members.

Although a preferred embodiment of this invention has been disclosed, a worker of ordinary skill in this art would recognize that certain modifications would come within the scope of this invention.

I claim:

1. A surgical positioner, comprising:
a first support member;
a second support member moveably joined to the first support member; and
a magnet operative to generate a magnetic force that attracts the first support member toward the second support member to resist relative movement between the first support member and the second support member.

2. The surgical positioner of claim 1, wherein the first support member includes a rounded portion received within a cupped portion of the second support member, the cup portion limiting relative movement of the rounded portion away from the cup portion.

3. The surgical positioner of claim 2, wherein in the rounded portion comprises at least a portion of the magnet.

4. The surgical positioner of claim 2, wherein the rounded portion comprises an outwardly facing surface and an inwardly facing surface, the cupped portion positioned adjacent the outwardly facing surface, and the magnet positioned adjacent the inwardly facing surface.

5. The surgical positioner of claim 4, wherein the magnet comprises a hemispherical shaped magnet.

6. The surgical positioner of claim 1, including a ball and socket joint configured to moveably join the first support member and the second support member.

7. The surgical positioner of claim 1, wherein the magnet comprises an electromagnet operative to generate a first magnetic field having a first magnetic force and a second magnetic field having a second magnetic force, the first magnetic force providing more resistance to relative movement between the first support member and the second support member than the second magnetic force.

8. The surgical positioner of claim 7, wherein the second magnetic force comprises no magnetic force.

9. The surgical positioner of claim 1, wherein the first member is a longitudinal member extending from a first end to an opposite, second end, the second member is pivotably joined to the first end, and a base member is pivotably joined to the second end, the magnet is operative to generate another magnetic force that attracts the second support member toward the base member to limit movement of the second support member relative to the base member.

10. The surgical position of claim 1, where the magnet comprises at least one magnet.

11. A surgical positioning assembly, comprising:
a base;
a first member secured to the base;
a second member pivotably secured to the first member at a first joint location; and
an electromagnetic system operative to vary an electromagnetic force near the first joint location between a stronger electromagnetic force and a weaker electromagnetic force, wherein the stronger electromagnetic force provides greater resistance to relative movement between the second member and the first member than the weaker electromagnetic force.

12. The assembly of claim 11, including a third member pivotably secured to the second member at a second joint location, wherein the electromagnetic system is operative to vary an electromagnetic force near the second joint location between a stronger electromagnetic force and a weaker electromagnetic force, wherein the stronger electromagnetic force provides greater resistance to relative movement between the second member and the first member than the weaker electromagnetic force.

13. The assembly of claim 11, including a foot pedal operative to initiate variance of the electromagnetic force between the stronger electromagnetic force and the weaker electromagnetic force.

14. The assembly of claim 11, wherein the weaker electromagnetic force comprises zero electromagnetic force.

15. A method of positioning a surgical positioner, comprising the steps of:
(a) pivoting a first member relative to a second member to a first pivot position; and
(b) holding the first member in the first pivot position using a magnet that attracts the first member toward the second member.

16. The method of claim 15, wherein said step (b) comprises holding the first member between the magnet and the second member.

17. The method of claim 15, including securing at least one of a portion of a patient or a surgical tool relative to the first member.

18. The method of claim 15, including pivoting the first member and the second member relative to a base member, and holding the second member against the third member using a magnet.

19. The method of claim 15, varying an electromagnetic force generated by the magnet between a stronger electromagnetic force and a weaker electromagnetic force, wherein the stronger electromagnetic force holds the first member in the first pivot position, and the weaker electromagnetic force permits pivoting the first member relative to the second member.
